(19) United States
(12) Patent Application Publication
(10) Pub. No.: US 2007/0116178 A1
(43) Pub. Date: May 24, 2007

(54) Control device for exiting of travelers with their luggage

(76) Inventor: Manuel Federico Hernandez Moysi, Barcelona (ES)

Correspondence Address: STRIKER, STRIKER & STENBY, 103 EAST NECK ROAD, HUNTINGTON, NY, 11743, US

(21) Appl. No.: 11/525,430

(22) Filed: Sep. 22, 2006

(30) Foreign Application Priority Data
Nov. 22, 2005 (ES) 200502562

(51) Int. Cl. G21K 5/10

(52) U.S. Cl. 378/69

(57) ABSTRACT

A control device for exiting of travelers with their luggage has an Identification tag attachable to a piece of luggage and carrying a code, a receipt to be given to a traveler for the piece of luggage and provided with a code and a reading unit configured for reading the code of the identification tag and the code of the receipt and comparing the codes, so that when the reading unit determines that the codes coincide with one another it is determined that the piece of luggage belongs to the traveler, and when the reading unit determines that the codes do not coincide with one another it is determined that the piece of luggage does not belong to the traveler.

### BACKGROUND OF THE INVENTION

The present invention relates to a control device for exiting travelers with their luggage.

More particularly, it relates to a control device for exiting travelers with their luggage, after delivering and picking up the luggage, at exit areas of airports, railroads, sea or bus stations and the like.

Strict and necessary entrance control of luggage and travelers is well known, namely for air traffic as a special safety measure against attacks and different attempts against persons and assets. The exhaustive control provides a thorough inspection of the luggage as well as of the travelers, by hand or with sophisticated detection and vision devices and other suitable means, when they pass through a well known detecting arch. This necessary and complete control of the luggage, as well as hand luggage carried by travelers is however not provided at the end of travel, or in other words when the luggage is delivered and picked up by travelers. In general, this operation is carried under a minimum control, so that any unscrupulous individual can take away objects and pieces of luggage which do not belong to him, with obvious unpleasant results for true owners.

### SUMMARY OF THE INVENTION

It is therefore an object of the present invention to provide a control device for exiting travelers with their luggage. More particularly, it is an object of the present invention to provide a control device for exiting travelers with their luggage, which ensures that the delivered luggage can be carried by actual owners of the luggage.

In keeping with these objects and with others which will become apparent hereinafter, one feature of the present invention resides, briefly stated, in a control device for exiting of travelers with their luggage, comprising an identification tag attachable to a piece of luggage and carrying a code; a receipt to be given to a traveler for the piece of luggage and provided with a code; and a reading unit configured for reading the code of the identification tag and the code of the receipt and comparing said codes, so that when said reading unit determines that the codes coincide with one another it is determined that the piece of luggage belongs to the traveler, and when said reading unit determines that the codes do not coincide with one another it is determined that the piece of luggage does not belong to the traveler.

It is another feature of the present invention that said reading unit is configured so that it produces at least one of a signal confirming that said codes coincide with one another and the piece of luggage belongs to the traveler, and a signal confirming that the codes do not coincide with one another and the piece of luggage does not belong to the traveler.

It is still a further feature of the present invention that said exit means receive each of said signals and correspondingly allowing the traveler with the piece of luggage to exit or do not allow the traveler with the piece of luggage to exit.

In accordance with another feature of the present invention said exit means is configured as a turnstile arranged at an exit location, or as a safety detection arch arranged at an exit.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic perspective view of a system for delivering and picking up luggage at a travelers station, located before an exit control area, and provided with one or several devices in accordance with the present invention;

FIG. 2 is a schematic front view of two devices in accordance with the present invention, as well as a beginning of a third device; and

FIG. 3 is a schematic side view, in perspective of the two devices in accordance with the present invention in an outwards exit position with the luggage.

### DESCRIPTION OF THE PREFERRED EMBODIMENTS

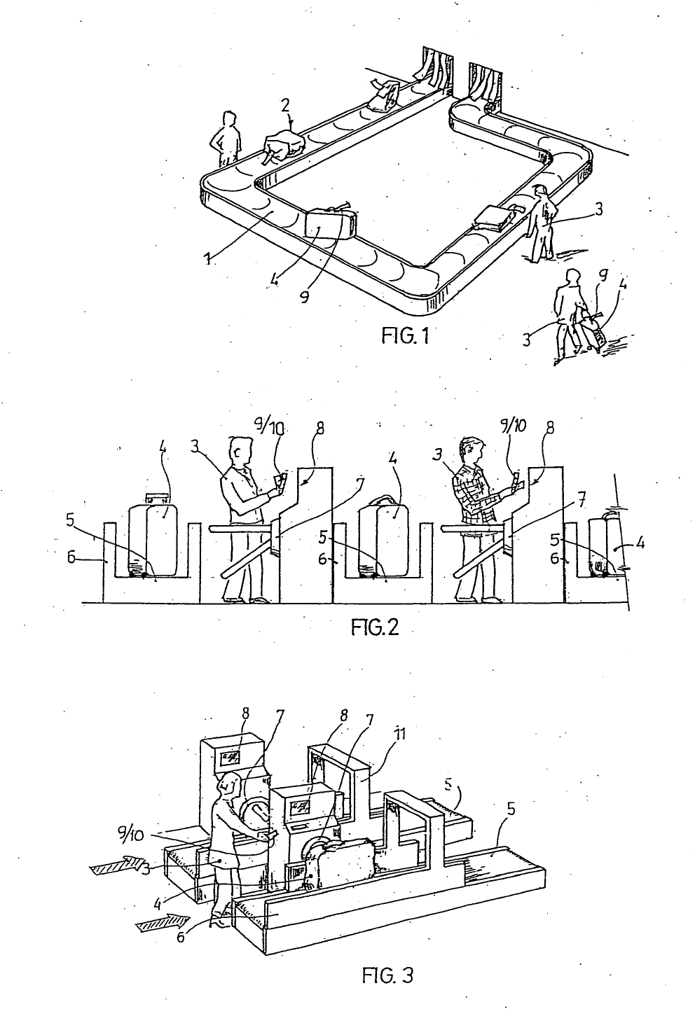

As shown in FIG. 1, a circuit of traveling band 1 delivers pieces of luggage 2 which come from a receiving area of a station or the like. Reference numeral 3 identifies travelers, and reference numeral 4 identifies pieces of luggage delivered by the traveling band 1.

A control device in accordance with the present invention is provided at an exit and includes a traveling band 5 with safety lateral sides 6, where the traveler 3 deposits the pieces of luggage 4. Turnstiles 7 are located near the traveling band 5 and configured as well known in the art.

The control device in accordance with the present invention further includes a tag 9 provided on the piece of luggage, which can be attached to the luggage originally during checking in of the luggage before the travel. At the same time, the traveler obtains a receipt 10 which also can be given to him originally during checking in for the travel. The tag 9 and the receipt 10 have corresponding codes which, for the same price of luggage, coincide with one another.

The control device in accordance with the present invention further has a reading unit which is identified with reference numeral 8. The reading unit 8 is configured to read the code provided on the tag 9 and the code provided on the receipt 10 and compare the codes.

When the reading unit 8 determines that the codes on the tag 9 and on the receipt 10 coincide with one another, it thereby confirms that the corresponding piece of luggage belongs to the corresponding traveler. It also provides a signal for allowing the traveler to exit with the corresponding piece of luggage.

The signal can be delivered to an inspector so that the inspector can be assured that the corresponding piece of luggage belongs to the traveler. The signal can be delivered so as to act automatically on a corresponding element to allow the traveler to exit with his piece of luggage. For example, the signal can activate the turnstile 7 so that it turns, thus allowing the traveler with his piece of luggage to exit. The signal can be delivered to the safety detecting arch 11, so as to allow the traveler with his piece of luggage to pass through the detecting arch. Also, any combinations of these solutions, as well as other solutions are possible.

If however the reading unit determines that the code on the receipt and the code of the tag do not coincide with one another, it provides an alert that the corresponding piece of luggage does not belong to the corresponding traveler. It also delivers a signal which does not allow a traveler to exit with a corresponding piece of luggage. This signal can be delivered to an inspector, to the turnstile 7, to the safety detecting arch 11, etc.

As a variation of this embodiment, the subsequent reading of the tag 9 of the piece of luggage 4 can be carried out with the related bar code and reading the receipt 10 of the tag of the piece of luggage 4 provided with an additional barcode (plus a safety digit), by means of a scanner located at the delivery control.

If the traveler has several pieces of luggage, the above described operation is repeated for each piece of luggage, piece-by-piece, stopped or continuously.

In accordance with another embodiment of the present invention, the above mentioned signal which confirms that the code of the tag and the code of the receipt coincide with one another, can simultaneously activate the traveling band 5 so that it delivers the corresponding piece of luggage 4 toward the turnstile 7 or the safety detection arch 11.

It is to be understood that if a traveler did not record his suitcases at the origin because he will carry them with him, it will be identified by a numbered tag or the like which will not allow the traveler to exit from the premises without passing through a visual control of an inspector. This is however not a part of the present invention.

It will be understood that each of the elements described above, or two or more together, may also find a useful application in other types of constructions differing from the type described above.

While the invention has been illustrated and described as embodied in a control device for exiting of travelers with their luggage, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A control device for exiting of travelers with their luggage, comprising an identification tag attachable to a piece of luggage and carrying a code; a receipt to be given to a traveler for the piece of luggage and provided with a code; and a reading unit configured for reading the code of the identification tag and the code of the receipt and comparing said codes, so that when said reading unit determines that the codes coincide with one another it is determined that the piece of luggage belongs to the traveler, and when said reading unit determines that the codes do not coincide with one another it is determined that the piece of luggage does not belong to the traveler.

2. A control device as defined in claim 1, wherein said reading unit is configured so that it produces at least one of a signal confirming that said codes coincide with one another and the piece of luggage belongs to the traveler, and a signal confirming that the codes do not coincide with one another and the piece of luggage does not belong to the traveler.

3. A control device as defined in claim 2; and further comprising an exit means for exiting the travelers, said exit means receiving each of said signals and correspondingly allowing the traveler with the piece of luggage to exit or not allowing the traveler with the piece of luggage to exit.

4. A control device as defined in claim 3, wherein said exit means is configured as a turnstile arranged at an exit location.

5. A control device as defined in claim 3, wherein said exit device is configured as a safety detection arch arranged at an exit location.

6. A control device as defined in claim 1; and further comprising means for moving pieces of luggage, said means for moving upon receiving each of said signals, moving a piece of luggage to an exit or not moving a piece of luggage to the exit.

7. A control device as defined in claim 1; and further comprising means for moving the pieces of luggage, said moving means receiving a plurality of said signals each for a corresponding piece of luggage, and being operative for stepped movement to move one piece of luggage after another in steps, when the signals confirming that the codes correspond to one another are received by said moving means.

8. A control device as defined in claim 1; and further comprising means for moving the pieces of luggage, said moving means receiving a plurality of said signals each for a corresponding piece of luggage, and being operative for a movement to move one piece of luggage after another instantly, when the signals confirming that the codes correspond to one another are received by said moving means.
